(19) United States
(12) Patent Application Publication
(10) Pub. No.: US 2024/0015785 A1
(43) Pub. Date: Jan. 11, 2024

(54) SYSTEMS, DEVICES, AND METHODS RELATED TO CONSERVING COMMUNICATION BANDWIDTH WITH SPARE TIME SCHEDULE

(71) Applicant: SKYWORKS SOLUTIONS, INC., Irvine, CA (US)

(72) Inventor: Samuel F. HISHMEH, Nolensville, TN (US)

(21) Appl. No.: 18/211,991

(22) Filed: Jun. 20, 2023

Related U.S. Application Data
(60) Provisional application No. 63/354,214, filed on Jun. 21, 2022.

(51) Int. Cl. H04W 74/04; H04L 1/08

(52) U.S. Cl. CPC H04W 74/04; H04L 1/08

(57) ABSTRACT

In some embodiments, a system can include a first client device connected to an arbiter device, a second client device connected to the arbiter device; and a wireless network architecture that provides a shared spare time during which one selected client device of the first client device or the second client device retransmits a portion of a previously transmitted message to the arbiter device.

### CROSS-REFERENCE TO RELATED APPLICATION(S)

This application claims priority to U.S. Provisional Application No. 63/354,214 filed Jun. 21, 2022, entitled CONSERVING COMMUNICATION BANDWIDTH WITH SPARE TIME SCHEDULE, the disclosure of which is hereby expressly incorporated by reference herein in its entirety.

### BACKGROUND

### Field

The present disclosure relates to improving availability or usage of bandwidth for a network topology having multiple wireless device connections.

### Description of the Related Art

An electronic device such as a computer, tablet, smartphone, or the like can interface with a user through a number of interface devices. Such interfacing functionality can be controlled and/or supported by, for example, an arbiter attached to or part of the electronic device, so as to allow appropriate transfer of information between the electronic device and the interface devices.

### SUMMARY

In accordance with a number of implementations, the present disclosure relates to a system including: a first client device connected to an arbiter device; a second client device connected to the arbiter device; and a wireless network architecture that provides a shared spare time during which one selected client device of the first client device or the second client device retransmits a portion of a previously transmitted message to the arbiter device.

In some embodiments, the wireless network architecture can provide a second shared spare time during which the arbiter device retransmits a second portion of a second previously transmitted message to the first client device.

In some embodiments, the arbiter device can send a spare time use scenario to the first client device.

In some embodiments, the spare time use scenario can select one device of the arbiter device or the first client device as a sender device that sends a message during the shared spare time.

In some embodiments, the spare time use scenario can inform the sender device to receive an acknowledgement in response to the message.

In some embodiments, the arbiter device can send a spare time schedule to the first client device.

In some embodiments, the spare time schedule can inform the first client device of a time instance in the future at which the shared spare time begins.

In some embodiments, the arbiter device can broadcast a spare time use scenario to the first client device and the second client device, the spare time use scenario including a first client device identifier.

In some embodiments, the arbiter device can select the first client device identifier for inclusion in the spare time use scenario over a second client device identifier based on a priority associated with the first client device.

In some embodiments, the priority can be determined based on a type of data stream established between the arbiter device and the first client device.

In some embodiments, the priority can be indicated by the first client device.

In some embodiments, the priority can be determined based a weighting scheme.

In some embodiments, the weighting scheme can consider at least one of a number of queued data packets, a number of unacknowledged audio packets, a signal strength of an established connection, a duration without a sniff event, or an inactive connection interval.

In some embodiments, the wireless network architecture can provide a second shared spare time during which the arbiter device schedules an environment scanning activity.

In some embodiments, the wireless network architecture can provide a second shared spare time during which the arbiter device searches for a third client device.

In some embodiments, the wireless network architecture can selectively reserve a second shared spare time during which the second client device retransmits a portion of a previously transmitted message.

In some embodiments, a wireless electronic device can be configured to send a spare time use scenario to a client device, send a spare time schedule to the client device, wait for a time instant specified in the spare time schedule, and transmitting a message according to the spare time use scenario over a specified spare time in the spare time schedule.

In some embodiments, the spare time use scenario can select a first client device over a second client device, the first client device and the second client device both sharing the spare time for retransmission of received data.

In some embodiments, the spare time use scenario can select a first client device over a second client device, the first client device and the second client device both sharing the spare time for retransmission of transmitted data.

In some embodiments, a computer-implemented method can include: determining a shared spare time during which an arbiter device connected to a first client device and a second client device is to retransmit a portion of a message previously transmitted by the arbiter device; determining a priority between the first client device and the second client device; broadcasting to the first client device and the second client device that the arbiter device will retransmit the portion during the shared spare time; and retransmitting the portion during the shared spare time.

For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1 depicts an example network topology of wireless electronic devices, in accordance with one or more embodiments.

FIGS. 2A-2B depict example spare time approaches, in accordance with one or more embodiments.

FIGS. 3A-3B depict example data structures 300, 350 that can be used to schedule one or more activities during a shared spare time, in accordance with one or more embodiments.

FIG. 4 depicts an example flowchart of a method that a device can use to communicate over a shared spare time, in accordance with one or more embodiments.

FIG. 5 depicts an example flowchart of a method that can dynamically reconfigure existing connections to make bandwidth available for a new connection, in accordance with one or more embodiments.

### DETAILED DESCRIPTION OF SOME EMBODIMENTS

The headings provided herein, if any, are for convenience only and do not necessarily affect the scope or meaning of the claimed invention.

Advancements in wireless connectivity has enabled many traditionally wired applications to become entirely wireless. Wireless gaming, wireless audio, and wireless charging are but a few such transformed applications that have gone from wired to wireless. Unfortunately, the transformation of wired to wireless is not without challenges.

One such challenge may arise in managing connectivity between wireless devices where available bandwidth is limited. Unlike in the past when relatively small number of devices were wireless, wireless devices are everywhere today. Take a typical home for an example. The home could house a smart TV, smart thermostat, smart light bulb, smart door security, smart media fobs, various smart sensors, and other wireless devices. Each of these devices vie for its share of bandwidth. This contentious use of limited bandwidth can result in congestion that can severely degrade wireless communication performance.

Unfortunately, conventional wireless networking architecture offers little to no relief in addressing the congested bandwidth usage. Under conventional technologies, each connected device reserves extra time (e.g., spare time) for retransmission of any data that could have been dropped. For example, a device may reserve 80 microseconds for data transmission and 5 microseconds for retransmission of any missing data. The reserved extra time remains unused if the device was successful in all of the data transmission and does not need to retransmit. Accordingly, the conventional technologies potentially waste usable bandwidth and limit number of devices that can connect. Improved approaches disclosed herein can address such challenges by intelligently structuring and sharing the spare time.

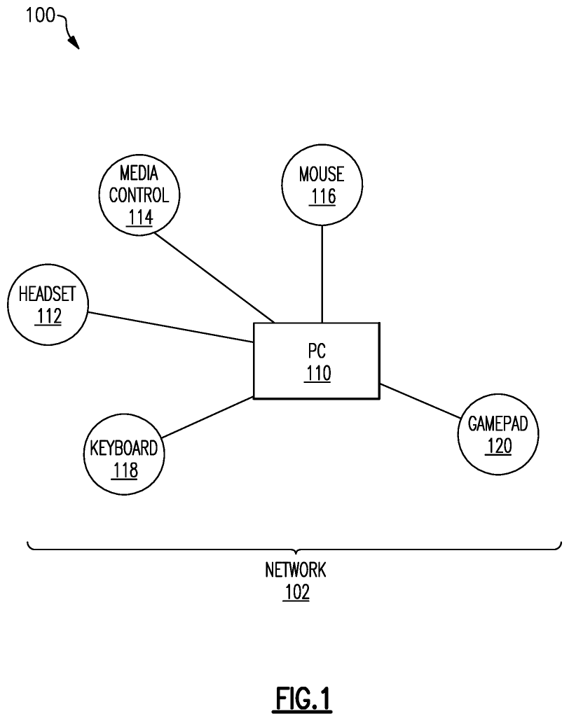

FIG. 1 depicts an example network topology 100 of wireless electronic devices, in accordance with one or more embodiments. The example network topology 100 includes a network 102. A PC 110 is a central hub of the network 102. The PC 110 is wirelessly connected to a headset 112, media control (e.g., a remote control) 114, wireless mouse 116, keyboard 118, and gamepad 120. In the present disclosure, the host device PC 110 is referred as “arbiter” or “arbiter device” and the wireless devices 112, 114, 116, 118, 120 are referred as “clients” or “client devices.” It is noted that while the example network topology 100 is depicted with a star topology, any topology including star, mesh, cluster-tree, combination thereof, or another topology are contemplated. In one or more of the other topologies, an arbiter may become or have a role of a client device and vice versa.

As described, when many client devices are communicating with an arbiter device, each client device may vie for a share of available bandwidth. For example, in FIG. 1, the client devices 112, 114, 116, 118, 120 are trying to communicate with the PC 110 and vying for bandwidth. Accordingly, the client devices 112, 114, 116, 118, 120 may experience degraded communication performance. While five client devices 112, 114, 116, 118, 120 are illustrated, any number of client devices may be considered.

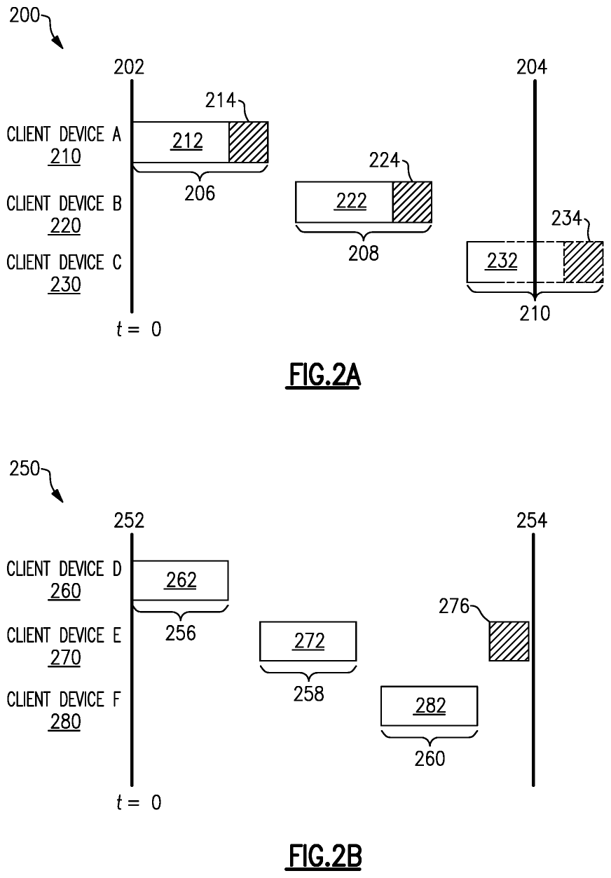

FIGS. 2A-2B depict example spare time approaches, in accordance with one or more embodiments. Specifically, FIG. 2A depicts a conventional spare time approach 200 and FIG. 2B depicts an improved spare time approach 250. In the FIGS. 2A-2B, time flows from the left lines 202, 252 (noted with t=0) toward the right lines 204, 254.

The conventional spare time approach 200 is described with a client device A 210, client device B 220, and client device C 230 that are connected to an arbiter device (not shown). Each of the client devices A, B, and C 210, 220, 230 can be allocated a respective communication interval during which the client device can receive or transmit data. For instance, the client device A 210 is allocated a first communication interval 206, the client device B 220 is allocated a second communication interval 208, and the client device C 230 is allocated a third communication interval 210.

Under the conventional spare time approach 200, each communication interval has a spare time portion reserved. For instance, the first communication interval 206 of the client device A 210 shows a data portion 212 and a spare time portion 214. Similarly, the second communication interval 208 of the client device B 220 shows a data portion 222 and a spare time portion 224. The third communication interval 232 of the client device C 230 is associated with a data portion 232 and a spare time portion 234. Here, each client device is reserved its own spare time.

The spare times 214, 224, 234 are reserved for retransmission of some previous data. For instance, if the client device A 210 had received some data previously but an arbiter device that sent the data did not receive an acknowledgement of successful receipt for a portion of the data from the client device A 210, the arbiter device may retransmit the portion to the client device A 210 within the spare time 214. If the client device A 210 had transmitted some data to the arbiter device but the arbiter device did not acknowledge successful receipt of a portion of the data, the client device A 210 may retransmit the portion to the arbiter device within the spare time 214.

Under the conventional spare time approach 200, available communication bandwidth is wasted due to each client device 210, 220, 230 having a spare time only for use by itself. As depicted, it can take a significant portion of a given duration (defined between the left line 202 and the right line 204) to communicate the first and second communication intervals 206, 208 that contain the respective spare times 214, 224. As a result, the third communication interval 210 cannot fit within the given duration. Thus, it can be seen that the conventional spare time approach 200 does not satisfactorily use the given duration for communications of the client devices A, B, and C 210, 220, 230.

In contrast, the improved spare time approach 250 of FIG. 2B allows better (arguably, optimal) use of the given duration. In FIG. 2B, the duration defined between the left line 252 and the right line 254 can be the same duration of FIG. 2A (the given duration). Here, a client device D 260, client device E 270, and client device F 280 are, respectively, allocated communication intervals 256, 258, 260 without spare times. In other words, respective data portions 262, 272, 282 are all of (or substantially all of) the communication intervals 256, 258, 260.

For any retransmissions, the improved spare time approach 250 can provide a shared spare time 276. Any of the client devices D, E, F 260, 270, 280 may retransmit or receive previously unacknowledged data during the shared spare time 276. For example, an arbiter device can specify which client device, if any, should retransmit during the shared spare time 276. As depicted, with the introduction of the shared spare time 276 that is reserved for multiple devices, a duration required to communicate data can be significantly reduced. For instance, data 262, 272, 282 having the same duration of data as the corresponding data portions 212, 222, 232 of FIG. 2A can all fit within the same duration. Thus, the improved spare time approach 250 can reduce wasted time and, therefore, increase bandwidth availability/usage. The reduction in wasted time and increased bandwidth availability/usage may become greater the larger the number of client device connections.

It is noted that the shared spare time 276 can be used by an arbiter device or a client device(s) for various communication purposes in addition to the described retransmission purpose. For instance, when an arbiter device or a client device determines that there is no missing data and thus there is no need for retransmission of the data, the device can repurpose the shared spare time 276 to send various commands, including another data portion. In other words, the shared spare time 276 can be used to schedule various activities involving data and/or command. Some examples of how the shared spare time 276 can be repurposed can include categories of:
1. Environment scanning;
2. Searching for new devices;
3. Arbiter device retransmissions;
4. Client device retransmissions;
5. Inactive connection communication; or
6. Other schedulable activities, including another data portion.
   These activities are not to be considered limiting and many variations are possible.

In some embodiments, an activity to be scheduled for the shared spare time 276 can be selected based on priority or importance. For example, a first client device may indicate to an arbiter device that its stream sends high priority data (e.g., audio and reserved bandwidth data) and a second client device may indicate to the arbiter device that its stream sends low priority data (e.g., asynchronous data). If the arbiter device needs to retransmit portions of both streams, then the arbiter device may select the high priority data over the low priority data for transmission during the shared spare time 276. Additionally, each of the categories above can be associated with a priority such that, for example, arbiter device transmissions (3) may take precedence over client device transmissions (4).

In some other embodiments, a device may select an activity to be scheduled in the shared spare time 276 based on a priority-based weighting scheme. The priority-based weighting scheme can be used to determine what activities to schedule in a spare time. The priority-based weighting scheme can take into account various factors, including any number of:
1. Number of queued data packets between devices;
2. Number of unacknowledged audio packets between devices;
3. Signal strength of a connection between devices—poor connections can be given lower priority to prevent a weak connection from affecting a strong connection;
4. Duration without a sniff event;
5. Duration without listening for a new connection; or
6. Inactive connection intervals.
   These factors are not to be considered limiting and many variations are possible. A priority of an activity can be determined based on such factors and a higher priority activity can be scheduled over a lower priority activity for the shared spare time 276.

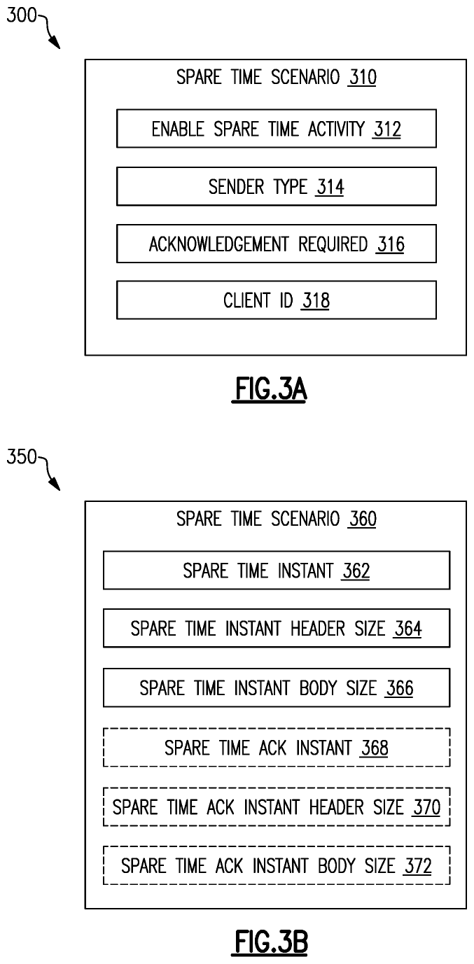

FIGS. 3A-3B depict example data structures 300, 350 that can be used to schedule one or more activities during a shared spare time (e.g., the shared spare time 276 of FIG. 2B), in accordance with one or more embodiments. Specifically, the data structure 300 of FIG. 3A can be used to communicate a spare time use scenario 310 to a client device(s). The spare time use scenario 310 can include an enable spare time activity field 312, sender type field 314, acknowledgement required field 316, and a client ID field 318, or other fields. These fields are not to be considered limiting and many variations are possible.

The enable spare time activity field 312 can specify whether there will be any messages transmitted or received over the shared spare time. For instance, the field 312 can have a bit (0 or 1) that indicates not sending a message (0) or sending a message (1).

The sender type field 314 can specify whether, if any, the message will be sent by an arbiter device or a client device. As an example, this field 314 can be a bit (0 or 1) that specifies a sender as an arbiter device (0) or a client device (1).

The acknowledgment required field 316 can specify whether a receiving device should acknowledge the message. As an example, this field 316 can be a bit (0 or 1) that specifies that an acknowledge is required (1) or otherwise (0).

The client ID field 318 can specify which client device should be the device that uses the shared spare time. For instance, if the sender type field 314 specifies that the sender should be a client device, then a client device having a specified ID should send a message over the shared spare time.

Once the fields 312, 314, 316, 318 are specified, an arbiter device can transmit a message with the specified spare time use scenario 310 to a client device(s). The client device receiving the message can determine, based on the message, whether or not to communicate over the shared spare time.

The data structure 350 of FIG. 3B can be used to communicate a spare time schedule 360 of when a share spare time should occur and for how long. The spare time schedule 360 can include a spare time instant field 362, a spare time instant header size field 364, and a spare time instant body size field 366, or other fields. Further, the spare time schedule 360 may optionally have a spare time acknowledge instant field 368, a spare time acknowledge instant header size field 370, and a spare time acknowledge instant body size field 372. These fields are not to be considered limiting and many variations are possible.

The spare time instant field 362 can specify when a shared spare time should occur. For instance, the field 362 can be a clock value or a counter value for when the shared spare time should occur. Thus, this field 362 can inform devices of when to expect the shared spare time.

The spare time instant header size field 364 and the spare time instant body size field 366 can specify how long the shared spare time should be. If a message to be send over the shared spare time has a header that is variable in length and a body, the spare time instant header size field 364 can indicate the varied header length. That is, the shared spare time 276 of FIG. 2B may have a variable length. In some implementations, the length of the shared spare time can be lengths of the head size and body size added together.

The spare time acknowledge instant field 368, spare time acknowledge instant header size field 370, and spare time acknowledge instant body size field 372 can be optional. If a message communicated over the shared spare time requires an acknowledgement (e.g., acknowledgment required field 316 of the spare time use scenario 310 sent is set to 1 in FIG. 3A), then these fields 368, 370, 372 can specify when and how long the acknowledgement should be in a similar manner with the previously described spare time fields 362, 364, 366.

Once some or all of the fields 362, 364, 366, 368, 370, 372 are specified, an arbiter device can transmit a message with the specified spare time schedule 360 to a client device(s). The client device receiving the message can expect when and how long to communicate with the arbiter device.

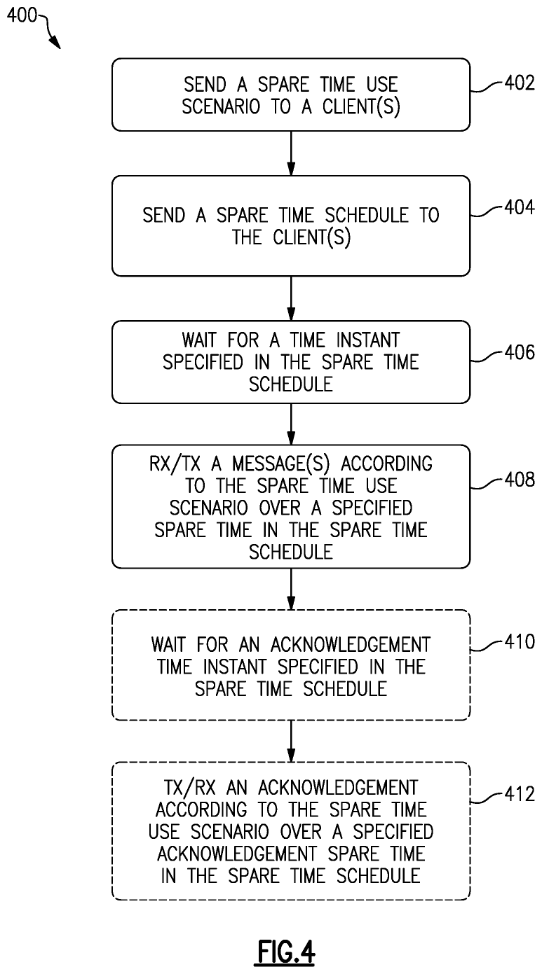

FIG. 4 depicts an example flowchart 400 of a method that a device can use to communicate over a shared spare time, in accordance with one or more embodiments. In some embodiments, the method can be implemented at an arbiter device and messages sent can be communicated as broadcast messages or targeted messages to one or more client devices.

At block 402, the arbiter device can send a spare time use scenario to the client devices. The spare time use scenario can be structured consistent with the spare time use scenario 310 of FIG. 3A.

At block 404, the arbiter device can send a spare time schedule to the client devices. The spare time schedule can be structured consistent with the spare time schedule 360 of FIG. 3B.

At block 406, the arbiter device can wait for a time instance specified in the spare time schedule. The time instance can be the spare time instant 362 of FIG. 3B.

At block 408, the arbiter device can receive or transmit a message(s) according to the spare time use scenario over a specified spare time in the spare time schedule.

At block 410, optionally, if the spare time use scenario required an acknowledgement, the arbiter device can wait for an acknowledgement time instant specified in the spare time schedule.

At block 412, optionally, for the acknowledgment, the arbiter device can transmit or receive the acknowledgment over a specified acknowledgment spare time in the spare time schedule.

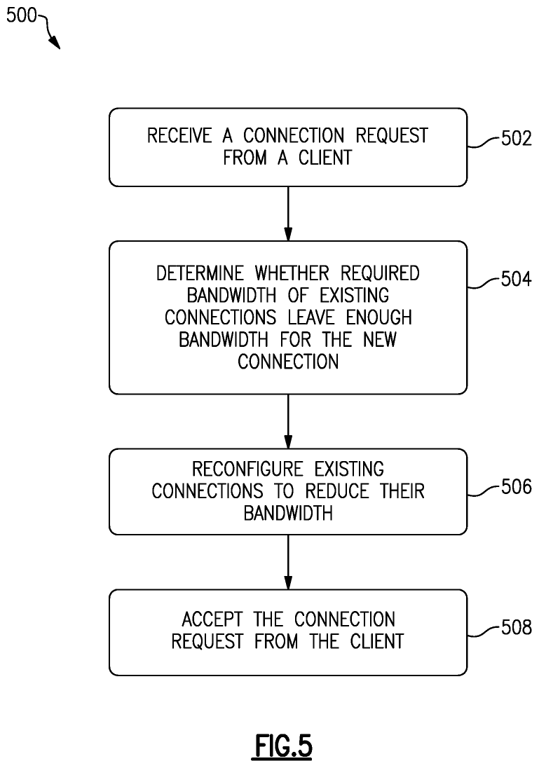

FIG. 5 depicts an example flowchart 500 of a method that can dynamically reconfigure existing connections to make bandwidth available for a new connection, in accordance with one or more embodiments.

At block 502, an arbiter device can receive a connection request from a client device. Here, the arbiter device can be connected to and communicating with multiple client devices over existing connections.

At block 504, the arbiter device can determine whether required bandwidth of the existing connections leave enough bandwidth for the new connection. If the arbiter determines that the existing connections do not leave enough bandwidth for the new connection, the arbiter can by default reject the new connection and the flow can terminate (not shown in the flowchart 500). However, if there is enough bandwidth available for the new connection or reconfiguration of the existing connections can make bandwidth available, the flow proceeds to block 506.

At block 506, the arbiter can reconfigure existing connections to reduce their bandwidth. As one example reconfiguration, the arbiter can change one or more allocated transaction lengths (e.g., communication intervals 256, 258, 260 of FIG. 2B) of existing connections within the minimum and maximum transaction lengths specified by the connected client devices. As another example, the arbiter can use the shared spare time as described above. The arbiter may determine the best possible configuration (e.g., lowest latency, lowest error rate, lowest missed data, or the like) for the available bandwidth, the least bandwidth use (e.g., lowest-bandwidth) configuration for the connected client devices, and any configurations in between. In some embodiments, the best possible configuration will be used originally but dynamically change configuration (scale down) toward the least bandwidth use configuration as network activity increases.

At block 508, the arbiter can accept the connection request from the client device, thus establishing a connection between the client device and the arbiter.

The present disclosure describes various features, no single one of which is solely responsible for the benefits described herein. It will be understood that various features described herein may be combined, modified, or omitted, as would be apparent to one of ordinary skill. Other combinations and sub-combinations than those specifically described herein will be apparent to one of ordinary skill, and are intended to form a part of this disclosure. Various methods are described herein in connection with various flowchart steps and/or phases. It will be understood that in many cases, certain steps and/or phases may be combined together such that multiple steps and/or phases shown in the flowcharts can be performed as a single step and/or phase. Also, certain steps and/or phases can be broken into additional sub-components to be performed separately. In some instances, the order of the steps and/or phases can be rearranged and certain steps and/or phases may be omitted entirely. Also, the methods described herein are to be understood to be open-ended, such that additional steps and/or phases to those shown and described herein can also be performed.

Some aspects of the systems and methods described herein can advantageously be implemented using, for example, computer software, hardware, firmware, or any combination of computer software, hardware, and firmware. Computer software can comprise computer executable code stored in a computer readable medium (e.g., non-transitory computer readable medium) that, when executed, performs the functions described herein. In some embodiments, computer-executable code is executed by one or more general purpose computer processors. A skilled artisan will appreciate, in light of this disclosure, that any feature or function that can be implemented using software to be executed on a general purpose computer can also be implemented using a different combination of hardware, software, or firmware. For example, such a module can be implemented completely in hardware using a combination of integrated circuits. Alternatively or additionally, such a feature or function can be implemented completely or partially using specialized computers designed to perform the particular functions described herein rather than by general purpose computers.

Multiple distributed computing devices can be substituted for any one computing device described herein. In such distributed embodiments, the functions of the one computing device are distributed (e.g., over a network) such that some functions are performed on each of the distributed computing devices.

Some embodiments may be described with reference to equations, algorithms, and/or flowchart illustrations. These methods may be implemented using computer program instructions executable on one or more computers. These methods may also be implemented as computer program products either separately, or as a component of an apparatus or system. In this regard, each equation, algorithm, block, or step of a flowchart, and combinations thereof, may be implemented by hardware, firmware, and/or software including one or more computer program instructions embodied in computer-readable program code logic. As will be appreciated, any such computer program instructions may be loaded onto one or more computers, including without limitation a general purpose computer or special purpose computer, or other programmable processing apparatus to produce a machine, such that the computer program instructions which execute on the computer(s) or other programmable processing device(s) implement the functions specified in the equations, algorithms, and/or flowcharts. It will also be understood that each equation, algorithm, and/or block in flowchart illustrations, and combinations thereof, may be implemented by special purpose hardware-based computer systems which perform the specified functions or steps, or combinations of special purpose hardware and computer-readable program code logic means.

Furthermore, computer program instructions, such as embodied in computer-readable program code logic, may also be stored in a computer readable memory (e.g., a non-transitory computer readable medium) that can direct one or more computers or other programmable processing devices to function in a particular manner, such that the instructions stored in the computer-readable memory implement the function(s) specified in the block(s) of the flowchart(s). The computer program instructions may also be loaded onto one or more computers or other programmable computing devices to cause a series of operational steps to be performed on the one or more computers or other programmable computing devices to produce a computer-implemented process such that the instructions which execute on the computer or other programmable processing apparatus provide steps for implementing the functions specified in the equation(s), algorithm(s), and/or block(s) of the flowchart(s).

Some or all of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium or device. The various functions disclosed herein may be embodied in such program instructions, although some or all of the disclosed functions may alternatively be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips and/or magnetic disks, into a different state.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list. The word “exemplary” is used exclusively herein to mean “serving as an example, instance, or illustration.” Any implementation described herein as “exemplary” is not necessarily to be construed as preferred or advantageous over other implementations.

The disclosure is not intended to be limited to the implementations shown herein. Various modifications to the implementations described in this disclosure may be readily apparent to those skilled in the art, and the generic principles defined herein may be applied to other implementations without departing from the spirit or scope of this disclosure. The teachings of the invention provided herein can be applied to other methods and systems, and are not limited to the methods and systems described above, and elements and acts of the various embodiments described above can be combined to provide further embodiments. Accordingly, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. A system comprising:
a first client device connected to an arbiter device;
a second client device connected to the arbiter device; and
a wireless network architecture that provides a shared spare time during which one selected client device of the first client device or the second client device retransmits a portion of a previously transmitted message to the arbiter device.

2. The system of claim 1 wherein the wireless network architecture provides a second shared spare time during which the arbiter device retransmits a second portion of a second previously transmitted message to the first client device.

3. The system of claim 1 wherein the arbiter device sends a spare time use scenario to the first client device.

4. The system of claim 3 wherein the spare time use scenario selects one device of the arbiter device or the first client device as a sender device that sends a message during the shared spare time.

5. The system of claim 4 wherein the spare time use scenario informs the sender device to receive an acknowledgement in response to the message.

6. The system of claim 1 wherein the arbiter device sends a spare time schedule to the first client device.

7. The system of claim 6 wherein the spare time schedule informs the first client device of a time instance in the future at which the shared spare time begins.

8. The system of claim 1 wherein the arbiter device broadcasts a spare time use scenario to the first client device and the second client device, the spare time use scenario including a first client device identifier.

9. The system of claim 8 wherein the arbiter device selects the first client device identifier for inclusion in the spare time use scenario over a second client device identifier based on a priority associated with the first client device.

10. The system of claim 9 wherein the priority is determined based on a type of data stream established between the arbiter device and the first client device.

11. The system of claim 9 wherein the priority is indicated by the first client device.

12. The system of claim 9 wherein the priority is determined based a weighting scheme.

13. The system of claim 12 wherein the weighting scheme considers at least one of a number of queued data packets, a number of unacknowledged audio packets, a signal strength of an established connection, a duration without a sniff event, or an inactive connection interval.

14. The system of claim 1 wherein the wireless network architecture provides a second shared spare time during which the arbiter device schedules an environment scanning activity.

15. The system of claim 1 wherein the wireless network architecture provides a second shared spare time during which the arbiter device searches for a third client device.

16. The system of claim 1 wherein the wireless network architecture selectively reserves a second shared spare time during which the second client device retransmits a portion of a previously transmitted message.

17. A wireless electronic device configured to send a spare time use scenario to a client device, send a spare time schedule to the client device, wait for a time instant specified in the spare time schedule, and transmitting a message according to the spare time use scenario over a specified spare time in the spare time schedule.

18. The wireless electronic device of claim 17 wherein the spare time use scenario selects a first client device over a second client device, the first client device and the second client device both sharing the spare time for retransmission of received data.

19. The wireless electronic device of claim 18 wherein the spare time use scenario selects a first client device over a second client device, the first client device and the second client device both sharing the spare time for retransmission of transmitted data.

20. A computer-implemented method comprising:
determining a shared spare time during which an arbiter device connected to a first client device and a second client device is to retransmit a portion of a message previously transmitted by the arbiter device;
determining a priority between the first client device and the second client device;
broadcasting to the first client device and the second client device that the arbiter device will retransmit the portion during the shared spare time; and
retransmitting the portion during the shared spare time.
